(19) United States
(12) Patent Application Publication
(10) Pub. No.: US 2003/0190544 A1
(43) Pub. Date: Oct. 9, 2003

(54) Toner for electrophotography and developer for electrophotography using the same, apparatus for forming image, and method for forming image

(75) Inventors: Tomoaki Tanaka, Kawasaki (JP); Yasushige Nakamura, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: FUJITSU LIMITED, Kawasaki (JP)

(21) Appl. No.: 10/265,784

(22) Filed: Oct. 8, 2002

(30) Foreign Application Priority Data
Mar. 19, 2002 (JP) 2002-077039

(51) Int. Cl. G03G 9/09

(52) U.S. Cl. 430/108.23; 430/124; 430/108.6

(57) ABSTRACT

A toner for electrophotography and the like that are excellent in color produceability, sublimination-resistance, and color reproduceability, and have no risk of fogging or printing defects of an image. The toner for electrophotography contains C.I. pigment Yellow 74 and C.I. pigment Yellow 180, in which the total content thereof is 7% by mass or less, the content of the C.I. pigment Yellow 74 is 5% by mass or less. A developer for electrophotography comprising the toner for electrophotography.

An apparatus for forming an image comprising an electrostatic latent image carrier; means for forming an electrostatic latent image on the electrostatic latent image carrier; means for developing by accommodating the toner for electrophotography, and forming a visible image by developing the electrostatic latent image; and means for transferring a transfer image formed by the visible image, onto a transfer material.

### CROSS-REFERENCE TO RELATED APPLICATIONS

This application is based upon and claims priority of Japanese Patent Application No. 2002-077039, filed in Mar. 19, 2002, the contents being incorporated herein by reference.

### BACKGROUND OF THE INVENTION

1. Field of the Invention

The present invention relates to a toner for electrophotography preferably used for a copier or a printer such as an electrophotographic copier, an electrophotographic printer, or an electrostatic recording apparatus, and in particular, preferably used for an image forming in which fixing of an image onto a transfer material is performed instantaneously by flash fixing, and a developer for electrophotography using the same, a method for forming an image, and an apparatus for forming an image.

2. Description of the Related Art

Conventionally, the following method is generally known as an electrophotographic method. Namely, onto an electrostatic latent image carrier (may also be referred to as a “photoconductive insulator”, a “photoconductive drum”, or the like), a static charge is uniformly applied by means for charging, and an optical image is applied thereto by means for exposing. In consequence, an electrostatic latent image is formed on the electrostatic latent image carrier. Then, the electrostatic latent image is developed by using a toner at the phase of a development means, to form a visible image. The resulting visible image is transferred onto a recording medium (may also be referred to as a “transfer material”, or the like) such as paper, by means for transferring to form a transfer image. Then, the transfer image is fixed on the transfer material by means for fixing to obtain a printed matter.

For the fixing, the toner constituting the transfer image transferred on the recording medium is fused by pressuring, heating, solvent vapor, light, or the like, and is fixed on the recording medium. Here, a flash fixing method of instantaneously irradiating the toner particles with an intense light, and fusing the toner is superior to other fixing methods attracts attention for the following reasons. Namely, with the flash fixing method, (1) fixing is performed in non-contact manner with a toner on the recording medium, hence fogging, a dust, or the like will not occur on the image in the process of fixing. Accordingly, the resolution does not deteriorate. Further, (2) no waiting time is necessary during power-on of an apparatus for forming an image, which allows for the quick start. (3) Even if a transfer material is stuck in a fixing unit due to a system malfunction, there is no risk of burning. (4) Fixing can be carried out on various kinds of papers such as adhesive paper, preprinted paper, pieces of paper with different thicknesses, or the like. There is no concern about the material and thickness of the transfer material.

In recent years, a flash fixing method utilizing a xenon flash lamp as a light source has come into common use among the aforementioned flash fixing methods. With the flash fixing method, the toner is fixed on the transfer material in the following manner. Namely, first, a visible image resulting from the toner is transferred from a photoconductive drum, or the like onto the transfer material to form a transfer image. At this time of transfer, the transfer image resulting from the toner is only deposited on the transfer material still in powdered state. Therefore, if the transfer image is rubbed with a finger, the transfer image will be destroyed. Next, the transfer image is irradiated with a flash such as a xenon flash. Then, the toner particles constituting the transfer image absorb the optical energy of the flash. The temperature of the toner is accordingly elevated, whereby the toner is softened, and closely fixed on the transfer material. After irradiation with a flash, the temperature decreases, and the transfer image on the transfer material is fused and solidified to form a fixed image.

The xenon flash lamp commonly used in the flash fixing method has a light emission distribution over a wide region from ultraviolet to infrared as shown in FIG. 1. The light emission intensity is particularly high in the near-infrared region of 800 to 1000 nm. Accordingly, a technology for efficiently absorbing the optical energy within this region is required for obtaining a toner having a high fixing performance.

In recent years, a color printed matter have been in increasing demand. Although the colorants to be used for a color toner have absorptivities in the visible region, many of them have low light absorptivities in the near-infrared region. For this reason, there is a demand for the development of a color toner providing good fixability with the flash fixing method.

Under such circumstances, it is proposed in the related art that a compound having a light absorption capability in the near-infrared region is used as an infrared absorber, and this is contained in a toner. For example, Japanese Patent Application Laid-Open (JP-A) Nos. 7-191492, 10-39535, and 11-65167 disclose as follow. As a compound having a light absorption capability in the near-infrared region, for example, an aminium salt, an indium-oxide-based metal oxide, a tin-oxide-based metal oxide, a zinc-oxide-based metal oxide, cadmium stannate, a specific amide compound, or the like is used as an infrared absorber, and allowed to be contained in the toner for enhancing the flashlight absorption capability.

However, many of the infrared absorbents are colored. Using such absorbents affects the color tone and the color produceability of the toner. Therefore, the absorbents that may be used are unfavorably limited to those with high color produceability. Further, for the flash fixing method, image-fixing is performed by an applying instantaneous high energy to a toner. When the high energy is applied thereto, the surface temperature of the toner at the instant reaches as high as 500° C. As a result, the pigment component in the toner is unfavorably decomposed; printing defects such as fogging due to sublimation, the change in color tone, or other problems may occur.

Therefore, a high color and an excellent sublimation resistance are related trade-off. Thus, there is a strong demand for the technology of capable of implementing both at higher level.

### SUMMARY OF THE INVENTION

It is therefore an object of the present invention to provide a toner for electrophotography which is excellent in color produceability, sublimation-resistance, and color reproducibility, and does not cause fogging of an image or printing defects, a developer for electrophotography, an apparatus for forming an image, and a method for forming an image.

A toner for electrophotography of the present invention comprises C.I. pigment Yellow 74 and C.I. pigment Yellow 180. The C.I. pigment Yellow 74 is a yellow pigment excellent in color produceability. The C.I. pigment Yellow 180 is a yellow pigment excellent in thermal decomposition-resistance and sublimation resistance. These yellow pigments are less varied in hue angle due to the mixing ratio. Therefore, in the toner for electrophotography using these pigments in combination, both the performances of sublimation-resistance and the high color produceability are implemented in a well-balanced manner at a high level without disturbing the color balance of red and green, i.e., secondary colors. Accordingly, the toner is also excellent in color reproducibility, and has no risk of causing fogging, or a printing defect, hence it is capable of forming a high quality image.

A developer for electrophotography of the present invention comprises the toner for electrophotography of the present invention.

An apparatus for forming an image of the present invention comprises; an electrostatic latent image carrier; means for forming an electrostatic latent image on the electrostatic latent image carrier; means for developing by accommodating the toner for electrophotography of the present invention, and developing the electrostatic latent image to form a visible image; and means for transferring a transfer image formed by the visible image, onto a transfer material. In the apparatus for forming an image, the means for forming an electrostatic latent image forms an electrostatic latent image on the electrostatic latent image carrier. The means for developing holds the developer for electrophotography, and develops the electrostatic latent image to form a visible image. The means for transferring transfers the visible image onto a transfer material to form a transfer image.

A method for forming an image of the present invention comprises a step for forming an electrostatic latent image on an electrostatic latent image carrier; a step for developing the electrostatic latent image using the toner for electrophotography of the present invention to form a visible image; and a step for transferring a transfer image formed by the visible image, onto a transfer material. For the method for forming an image, the step for forming an electrostatic latent image, an electrostatic latent image is formed on an electrostatic latent image carrier. In the step for developing, the electrostatic latent image is developed by the toner for electrophotography, so that a visible image is formed. In the step for transferring, the visible image is transferred onto a transfer material.

### BRIEF DESCRIPTION OF DRAWINGS

FIG. 1 is a graph showing one example of the light emission spectrum of a xenon flash lamp.

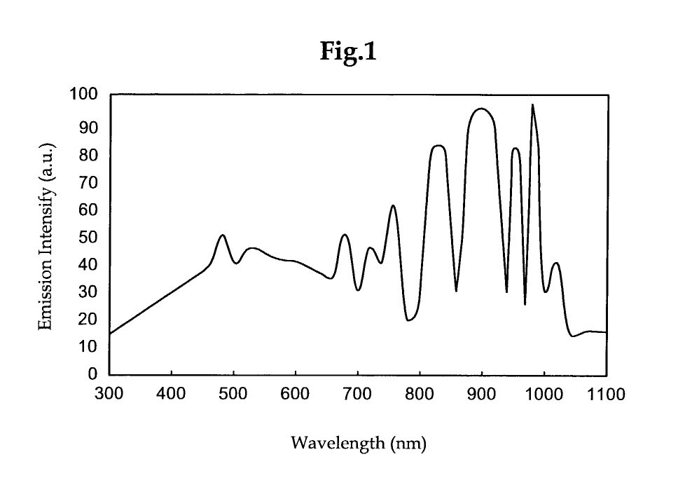

### DESCRIPTION OF THE PREFERRED EMBODIMENTS

(Toner for Electrophotography)

A toner for electrophotography of the present invention contains C.I. pigment Yellow 74 and C.I. pigment Yellow 180, and it contains a colorant, a binder resin, an infrared absorber, a charge control agent, and the like.

The C.I. pigment Yellow 74 is a yellow pigment excellent in color produceability.

The content of the C.I. pigment Yellow 74 is not particularly restricted, and can be appropriately selected according to the object. It is preferably 5% by mass or less, and more preferably 4% by mass or less.

If the content exceeds 5% by mass, it may cause insufficient sublimation-resistance, hence fogging or printing defects on an image may occur.

The C.I. pigment Yellow 180 is a yellow pigment excellent in thermal decomposition resistance and sublimation-resistance.

The content of the C.I. pigment Yellow 180 is not particularly restricted, and can be appropriately selected according to the object. It is preferably 5% by mass or less, and more preferably 4% by mass or less.

If the content exceeds 5% by mass, the dispersibility of the raw material is degraded. Accordingly, the chroma may lower.

The total content of the C.I. pigment Yellow 74 and the C.I. pigment Yellow 180 is not particularly restricted, and can be appropriately selected according to the object. It is preferably 7% by mass or less, and more preferably 5% by mass or less.

If the total content exceeds 7% by mass, it may be impossible to obtain a toner for electrophotography, in which both color produceability and sublimation-resistance have been realized in a well-balanced manner at a high level.

The colorant other than the C.I. pigment Yellow 74 and the C.I. pigment Yellow 180 is not particularly restricted, and can be appropriately selected according to the object. It can be appropriately selected from any known dyes, pigments, and the like, of black, red, yellow, blue, and green colors, and the like.

Examples of the black colorant include: various carbon blacks prepared by a thermal black method, an acetylene black method, a channel black method, a lamp black method, and the like, a grafted carbon black obtained by coating the surface of carbon black with a resin, inorganic pigments such as ferrite, iron black, and magnetite, chromatic colored dyes and organic pigments, nigrosine dyes, and azo dyes.

Examples of the red colorant may include: anthraquinone, quinacridone, bisazo-based dyes, monoazo-based dyes and the like.

Examples of the yellow colorant may include: anilide compounds, benzidine, benzimidazolone, bisazo-based dyes and the like.

Examples of the blue colorant may include phthalocyanine and the like.

Examples of the green colorant may include halogenated phthalocyanine and the like.

These colorants may be used alone, or may also be used in combination of two or more.

The content of the colorant in the toner for electrophotography is not particularly restricted. It is preferably 0.1 to 10% by mass, and more preferably 2 to 5% by mass.

If the content is less than 0.1% by mass, the color degree of the image fixed on a transfer material (recording medium) such as a transfer material may deteriorate. If it exceeds 10% by mass, various characteristics such as charging stability in the toner may deteriorate, which may lead to higher cost of materials.

The binder resin is not particularly restricted, and can be appropriately selected according to the object. Examples of the binder resin include thermoplastic resins such as natural polymers, synthetic polymers and the like. Specific examples include epoxy resins, styrene-acrylic resins, polyacrylic resins, polyamide resins, polyester resins, polyvinyl resins, polyurethane resins, polybutadiene resins and the like. Polyester resins are preferred among those, in terms of fixability and resin strength.

The weight-average molecular weight and the melting point of the binder resin are not particularly restricted, and can be appropriately selected according to the object. For example, it is preferable that the weight average molecular weight is about 4000 to 100000, and that the melting point is about 90 to 150° C.

The content of the binder resin in the toner for electrophotography is not particularly restricted, and can be appropriately selected according to the object. It is preferably 50% by mass or more, and more preferably 50 to 95% by mass in terms of charging ability.

The infrared absorber can be preferably used when the toner for electrophotography is used as a toner for flash fixing.

The infrared absorber is not particularly restricted, and can be appropriately selected from any known infrared absorbents. The examples include aminium compounds, diimonium compounds, cyanine compounds, polymethine-based compounds, nickel complex compounds, phthalocyanine-based compound, indium-oxide-based metal oxides, tin-oxide-based metal oxides such as tin oxide, zinc-oxide-based metal oxides, lanthanoid compounds, cadmium stannate, and specific amide compounds.

The content of the infrared absorber in the toner for electrophotography is, for example, preferably from 0.1 to 20% by mass, and more preferably from 0.5 to 5% by mass.

If the content is less than 0.1% by mass, the optical energy absorption performance in the near-infrared region of the toner for electrophotography is reduced, which may cause insufficient fixing. On the other hand, if it exceeds 20% by mass, it is still possible to achieve the good fixing performance, though, it still may cause problems such as insufficient charging or a change in hue.

The charge control agent is dispersed in the binder resin for the purpose of controlling the charge amount of the toner for electrophotography within a desired range.

As for the charge control agent, either a positive charge control agent or a negative charge control agent is properly used depending on either positively or negatively the binder resin is charged. Examples of the positive charge control agent include: nigrosine dyes (black), quaternary ammonium salts (colorless), and triphenylmethane derivatives (blue). Further, examples of the negative charge control agent include: metal-containing azo complexes, zinc naphthoate complexes (colorless), zinc salicylate complex (colorless), calixarene-based compounds, boron compounds, and the like. These may be used alone, or may also be used in combination of two or more thereof.

The color of the charge control agent is not particularly restricted, and can be appropriately selected according to the object. Those colorless or light-colored are preferred in terms of their smaller influences on the hue of the toner for electrophotography.

The content of the charge control agent in the toner for electrophotography is, for example, preferably 5% by mass or less, and more preferably 3% by mass or less.

The toner for electrophotography may further contain other components appropriately selected according to the object. Preferred examples of the other components include a fixing aide and a fluidizing agent.

Examples of the fixing aids include wax, metallic soap, and surfactants.

Examples of the wax include: all of the known wax including, polyolefin wax such as polyethylene wax and polypropylene wax, fatty acid ester waxes, paraffin wax, carnauba wax, amide-based wax, and acid-modified polyethylene wax. These may be used alone, or may also be used in combination of two or more. The wax having a softening point of 150° C. or less are preferred among those, and particularly, the wax with a lower softening point than the fusing and softening point of the binder resin are preferred.

Examples of the metallic soap include zinc stearate and the like.

Examples of the surfactant include non-ionic surfactants and the like.

The fluiding agent is not particularly restricted, and can be appropriately selected according to the object. Examples include inorganic fine particles, resin particles, and the like.

The inorganic fine particles are preferably added to the toner for electrophotography.

The particle diameter of the inorganic fine particles is preferably from 5 nm to 2 μm, and more preferably from 5 nm to 500 nm in primary particle diameter (number average particle diameter (D₅₀)).

The specific surface area based on a BET method of the inorganic fine particles is preferably 20 to 500 m²/g.

Examples of the inorganic fine particles include silica fine particles, alumina, titanium oxide, barium titanate, magnesium titanate, calcium titanate, strontium titanate, zinc oxide, quartz sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, silicon nitride, and the like. Silica fine particles are particularly preferred among those. Those may be used alone, or may also be used in combination with two or more.

Examples of the resin particles include polystyrene, polymethyl methacrylate (PMMA), melamine resins and the like. These may be used alone, or may also be used in combination of two or more.

The amount of the fluidizing agent to be added to the toner for electrophotography is preferably 0.01 to 5 parts by mass, and more preferably 0.01 to 2.0 parts by mass per 100 parts by mass of the toner for electrophotography (except for the amount of the fluidizing agent).

The method for manufacturing the toner for electrophotography is not particularly restricted, and can be appropriately selected from any known methods according to the object. Examples include a grinding method and a polymerization method.

Examples of the grinding method may include the following mechanical grinding methods. Namely, the binder resin, the infrared absorber, the fixing aid, the colorant, the charge control agent, the other components, and the like are mixed by means for a mixing device such as a Henschel mixer and the like. The resulting mixture is melted and kneaded by means for a kneading machine such as a kneader and an extruder. The mixture obtained is then roughly ground. The ground pieces are finely ground by means for a grinding machine such as a jet mill and the like, and the resulting particles are classified into a desired particle diameter by means for an air classifier, or the like. Thereafter, an additive is added thereto to manufacture toner particles.

Examples of the method for polymerization include a suspension polymerization method and an emulsion polymerization method.

Examples of the suspension polymerization method include the following methods. Namely, monomers such as styrene, butyl acrylate, 2-ethylhexyl acrylate and the like, a cross-linking agent such as divinylbenzene and the like, a chain transfer agent such as dodecyl mercaptan and the like, the colorant, the charge control agent, the infrared absorber, the fixing aid, a polymerization initiator, and the like are mixed to produce a monomer composition. Thereafter, the monomer composition is put into an aqueous phase containing a suspension stabilizer such as tricalcium phosphate, polyvinyl alcohol and the like, and a surfactant to produce an emulsion by means of a rotor stator type emulsifier, a high pressure type emulsifier, an ultrasonic type emulsifier, and the like. Then, the monomers are polymerized by heating. After completing polymerization, the particles are washed and dried. Then, an additive is appropriately added thereto to obtain toner particles in final state.

Examples of the emulsion polymerization method include the following methods. Namely, in a water soluble polymerization initiator such as potassium persulfate and the like dissolved in water, monomers such as styrene, butyl acrylate, 2-ethylhexyl acrylate, and the like, and, if necessary, a surfactant such as sodium dodecyl sulfate and the like are added. The mixture was heated and polymerized with stirring to obtain resin particles. Thereafter, powder of the infrared absorber, the colorant, the charge control agent, the fixing assistant, and the like are added into a suspension in which resin particles are dispersed. By adjusting the pH of the suspension, the stirring strength, the temperature, and the like, the resin particles, the infrared absorbent powder and the like are hetero-flocculated. Further, the hetero flocculate is heated at the glass transition point higher than the glass transition point of the resin contained, and it is fused to obtain toner particles. Subsequently, the resulting toner particles are washed and dried. Then, an additive is appropriately added thereto in order to obtain final toner particles.

The toner for electrophotography of the present invention is, as described above, excellent in color produceability, sublimation-resistance, and color reproducibility, and has no risk of causing fogging, or a printing defect, hence it is capable of forming a high quality image. Therefore, the toner can be preferably used in various fields, and can be preferably used for the following developer for electrophotography, apparatus for forming an image and method for forming an image of the present invention.

(Developer for Electrophotography)

A developer for electrophotography of the present invention comprises at least the toner for electrophotography of the present invention, and appropriately selected other components.

The developer for electrophotography may be a one-component developer made of the toner for electrophotography, or may also be a two-component developer containing the toner for electrophotography and a carrier. However, when used for a high-speed printer corresponding to recent improvement in fast information processing, or the like, the two-component developer is preferred in terms of longer lifetime, and the like.

The carrier is not particularly restricted, and can be appropriately selected according to the object. Those having a core material and a resin layer covering the core material are preferred.

Preferred examples of the material for the core material may include 50 to 90-emu/g manganese-strontium (Mn—Sr) materials and manganese-magnesium (Mn—Mg) materials. High magnetization materials such as iron powder (100 emu/g or more) and magnetite (75 to 120 emu/g) are also preferred from the viewpoint of ensuring the image concentration. Low magnetization materials such as copper-zinc (Cu—Zn) (30 to 80 emu/ g) are, too, preferred with the respect that the resulting carrier can touch more softly to the photoconductor on which the toner particles are disposed in a state of standing upwards, which is advantageous for enhancing the quality of the image. These may be used alone, or may also be used in combination with two or more.

The particle diameter of the core material is preferably from 10 to 150 μm, and more preferably 40 to 100 μm in average particle diameter (volume average particle diameter (D₅₀)).

If the average particle diameter (volume average particle diameter (D₅₀)) is less than 10 μm, the amount of fine-powder type particles increases in the distribution of carrier particles. As a result, the magnetization per particle becomes lower, which may cause scattering of carrier particles. If it exceeds 150 μm, the specific surface area becomes smaller, which may cause scattering of toner particles. In particular, for a full-color image with a large amount of filled-in portions, the filled-in portions may be reproduced poorly.

The materials for the resin layer is not particularly restricted, and can be appropriately selected from known materials according to the object. Considering the durability and the longer lifetime, preferred examples include: silicone resins such as silicone resin, acrylic-modified silicone-based resins, and fluorine-modified silicone resins, and the like. These may be used alone, or may also be used in combination with two or more.

The resin layer can be formed in the following manner. For example, the silicone resin, or the like is dissolved in a solvent to prepare a coating solution. Then, the coating solution is uniformly coated on the surface of the core material by any known coating methods such as a dipping method, a spray method, or a brushing method. The applied coating solution is dried, followed by burning, or the like.

The solvent is not particularly restricted, and can be appropriately selected according to the object. Examples include: toluene, xylene, methyl ethyl ketone, methyl isobutyl ketone, and butyl cellosolve acetate.

The burning can be implemented by an externally heating method, or an internally heating method, examples of which may include: a method using a fixed-type electric furnace, a fluid-type electric furnace, a rotary-type electric furnace, a burner furnace, or the like and a method using a microwave.

The proportion of the resin layer in the carrier (resin coating amount) is preferably from 0.01 to 5.0% by mass based on the total amount of the carrier.

If the proportion (resin coating amount) is less than 0.01% by mass, it may be impossible to form the resin layer uniformly on the surface of the core material. If it exceeds 5.0% by mass, the resulting resin layer may be too thick, hence granulation occurs among carrier particles. Consequently, it may be impossible to obtain uniform carrier particles.

When the developer for electrophotography is the two-component developer, the content of the carrier in the two-component developer is not particularly restricted, and can be appropriately selected according to the object. For example, it is preferably 90 to 98% by mass, and more preferably 93 to 97% by mass.

The developer for electrophotography of the present invention comprises the toner for electrophotography of the present invention. Accordingly, it is excellent in color produceability, sublimation resistance, and color reproducibility, and has no risk of causing the fogging, or a printing defect, hence it is capable of forming a high quality image with stability.

The developer for electrophotography of the present invention can be preferably used for image-forming by various known electrophotographic methods such as a magnetic one-component developing method, a non-magnetic one-component developing method, and a two-component developing method. It can be preferably used for the following apparatus for forming an image and method for forming an image of the present invention.

(Method for Forming an Image and Apparatus for Forming an Image)

The method for forming an image of the present invention includes a step for forming an electrostatic latent image, a step for developing, and a step for transferring, and preferably it further includes a step for fixing. If necessary, it may also include appropriately selected other steps such as a step for charge eliminating, a step for cleaning, a step for recycling, and a step for controlling.

The apparatus for forming an image of the present invention includes an electrostatic latent image carrier, means for forming an electrostatic latent image, means for developing, and means for transferring, and preferably further includes means for fixing. If necessary, it may also include appropriately selected other means such as a charge eliminating means, a cleaning means, a recycling means, and a control means.

The method for forming an image of the present invention can be preferably carried out by the apparatus for forming an image of the present invention. The step for forming an electrostatic latent image can be carried out by the electrostatic latent image-forming means. The step for developing can be carried out by the means for developing. The step for transferring can be carried out by the means for transferring. The step for fixing can be carried out by the means for fixing. The other steps can be carried out by the other means.

—Step for Forming an Electrostatic Latent Image and Means for Forming an Electrostatic Latent Image—

The step for forming an electrostatic latent image is a step for forming an electrostatic latent image on an electrostatic latent image carrier.

The electrostatic latent image carrier (may be referred to as a “photoconductive insulator”, or a “photoconductor”) is not particularly restricted as to the material, shape, structure, size, quality of material, and the like, and can be appropriately selected from any known ones. Regarding the shape, it may be preferably drum-like shape. Examples of the material include inorganic photoconductors such as amorphous silicon, selenium, and the like, and organic photoconductors such as polysilane, phthalocyanine, and the like.

The electrostatic latent image can be formed in the following manner. For example, after uniformly charged, the surface of the electrostatic latent image carrier is exposed imagewise. This can be carried out by the electrostatic latent image-forming means.

The electrostatic latent image-forming means includes at least a charger for uniformly charging the surface of the electrostatic latent image carrier, and an exposing unit for exposing the surface of the electrostatic latent image carrier imagewise.

The charging can be achieved by, for example, impressing a voltage on the surface of the electrostatic latent image carrier with the charger.

The charger is not particularly restricted, and can be appropriately selected according to the object. Examples include any known contact chargers that comprises conductive or semiconductive roll, brush, film, rubber blade, and the like, and non-contact chargers utilizing corona discharge, such as a corotron, a scorotron and the like.

The exposure can be achieved by, for example, imagewise exposing the surface of the electrostatic latent image carrier with the exposing unit.

The exposing unit is not particularly restricted as long as it is capable of exposing imagewise on the surface of the electrostatic latent image carrier charged by the charger. It can be appropriately selected according to the object. Examples include various exposing units such as a copying optical system, a rod lens array system, a laser optical system, a liquid crystal shutter optical system, and the like.

In the present invention, an optical back process may also be adopted, in which the electrostatic latent image carrier is exposed imagewise from its back side.

—A Step for Developing and Means for Developing—

The step for developing is a step for developing the electrostatic latent image using the developer for electrophotography, and then forming a visible image.

The visible image can be formed by, for example, developing the electrostatic latent image using the developer for electrophotography, and the formation can be achieved by the means for developing.

The means for developing has at least a developing unit accommodating the developer for electrophotography, and supplying the developer for electrophotography to the electrostatic latent image in a contact or non-contact manner.

The developing unit may be of a dry development system, or it may also be of a wet development system. Alternatively, it may be a developing unit for monochrome, or a developing unit for multicolor. Preferred examples include the unit having a stirrer for friction-stirring and charging the developer for electrophotography, a rotatable magnet roller, and the like.

In the developing unit, for example, the toner for electrophotography and the carrier are mixed and aggregated. The toner for electrophotography is charged due to the friction at this step, and is disposed and held in a state of standing upwards on the surface of the rotating magnet roller, to form a magnetic brush. The magnet roller is placed in the near-field of the electrostatic latent image carrier (photoconductor). Therefore, a part of the toner for electrophotography constituting the magnetic brush formed on the surface of the magnet roller moves onto the surface of the electrostatic latent image carrier (photoconductor) by the electric attraction force. As a result, the electrostatic latent image is developed by the toner for electrophotography, hence a visible image by the toner is formed on the surface of the electrostatic latent image carrier (photoconductor).

The developer to be accommodated in the developing unit is the developer for electrophotography of the present invention. The developer for electrophotography may be a one-component developer or may also be a two-component developer. The toner contained in the developer for electrophotography is the toner for electrophotography of the present invention containing C.I. pigment Yellow 74 and C.I. pigment Yellow 180. For multicolor development, it can be appropriately used in combination with a chromatic colored toner selected from a black toner, a magenta toner, and a cyan toner. For full color, a yellow toner, a black toner, a magenta toner, and a cyan toner are used.

—A Step for Transferring and Means for Transferring—

The step for transferring is a step for transferring a transfer image formed by the visible image onto a transfer material.

The transfer of the visible image can be carried out by, for example, using a transfer charger which is given an opposite polarity to that of the toner for electrophotography. The step can be carried out by the means for transferring.

The means for transferring has at least a transfer unit for peeling and charging the visible image formed on the electrostatic latent image carrier (photoconductor), and transferring it onto the transfer material side.

Examples of the transfer unit may include: a corona transfer unit by corona discharge, a transfer belt, a transfer roller, a pressure transfer roller, an adhesion transfer roller, and the like.

Incidentally, the transfer material is not particularly restricted, and can be appropriately selected from any known recording media (transfer material).

—Step for Fixing and Means for Fixing—

The step for fixing is a step for fixing the transfer image transferred onto the transfer material by means for a fixing apparatus.

The fixing may be implemented, for example, by heating and pressuring the transferred image on the transfer material with a heat fixing roller, however, flash fixing is more preferred, which can be carried out by the means for fixing.

Using a flash fixing unit and the means for flash fixing, the flash fixing can be achieved by, for example, irradiating the transfer image transferred onto the transfer material with light.

The means for flash fixing has at least a flash lamp for emitting an infrared ray.

The flash lamp is not particularly restricted, and can be appropriately selected according to the object. Preferred examples include an infrared lamp and a xenon lamp. Among these, the xenon flash lamp having a high light emission intensity within a wavelength range of 700 to 1000 nm is particularly preferred.

The flash energy for the flash fixing is preferably about 1 to 3 J/cm².

If the flash energy is less than 1 J/cm², the fixing may not be carried out favorably: On the other hand, if it exceeds 3 J/cm², a toner void, a burn of paper, and the like may occur.

The step for charge eliminating is a step for eliminating charges through overall exposure or impression of a discharge bias on the electrostatic latent image carrier, and can be preferably carried out by means for charge eliminating.

The means for charge eliminating is not particularly restricted so long as it is capable of performing exposure or impression with a discharge bias on the electrostatic latent image carrier. It can be appropriately selected from any known charge eliminators.

The step for cleaning is a step for removing the toner for electrophotography remaining on the electrostatic latent image carrier, and can be preferably carried out by a cleaning means.

The cleaning means is not particularly restricted as long as it is capable of removing the toner for electrophotography remaining on the electrostatic latent image carrier. It can be appropriately selected from any known cleaners. Examples include a magnetic brush cleaner, an electrostatic brush cleaner, a magnetic roller cleaner, a blade cleaner, a brush cleaner, a web cleaner, and the like.

The step for recycling is a step for recycling the toner for electrophotography removed by the step for cleaning, and re-using it as the means for developing. The step can be appropriately carried out by means for recycling.

The means for recycling is not particularly restricted. Examples include any known carrying means.

The means for controlling is not particularly restricted so long as it is capable of controlling how each means described above works. It can be appropriately selected according to the object. Examples include instruments such as a sequencer and a computer.

In the method for forming an image of the present invention, an electrostatic latent image is formed on an electrostatic latent image carrier, in the step for electrostatic latent image-forming. In the step for developing, the electrostatic latent image is developed by the developer for electrophotography to form a visible image. In the step for transferring, the visible image is transferred onto a transfer material. In the step for fixing, the transfer image transferred onto the transfer material is fixed. As a result, an image is formed on the transfer material. In consequence, the image is fixed and formed on the transfer material at a very high speed.

Whereas, in the apparatus for forming an image of the present invention, the means for forming an electrostatic latent image forms an electrostatic latent image on an electrostatic latent image carrier. The means for developing accommodates the developer for electrophotography, and develops the electrostatic latent image to form a visible image. The means for transferring plays a role of transferring a transfer image formed by the visible image onto a transfer material. The means for fixing plays a role of fixing the transfer image transferred onto the transfer material. As a result, an image is fixed and formed on the transfer material at a very high speed.

According to the apparatus for forming an image and the method for forming an image, the developer for electrophotography of the present invention containing the toner for electrophotography of the present invention is used as the developer for electrophotography. Therefore, the color produceability, the sublimation-resistance, and the color reproducibility are excellent, and there is no risk of fogging of an image and printing defects. Thus, it is possible to form a high quality image.

Hereinafter, the present invention will be described with examples. The scope of the present invention is not restricted at all.

### EXAMPLES 1 TO 10 AND COMPARATIVE EXAMPLES 1 TO 9

—Manufacturing of Toner for Electrophotography (Toner for Flash Fixing)—

As a binder resin, a sulfonic acid-modified polyester resin (acid value; 30 mg/KOH, softening point; 104° C.) containing a terephthalic acid, an ethylene oxide adduct of bisphenol A, and bis(4-hydroxyphenyl)sulfonic acid as indispensable constituent monomers were used. To the binder resin, each of C.I. pigment Yellow 74 (IRGALITE YELLOW GO; manufactured by Chiba Specialty Chemicals K.K.) and C.I. pigment Yellow 180 (Novoperm P—HG; manufactured by Clariant Japan K.K.) were added as shown in Tables 1 and 2. Then, 3% by mass of a calixarene compound (E-89, manufactured by Orient Co.), 0.65% by mass of naphthalocyanine YKR-5010 (manufactured by Yamamoto Chemicals Inc.), and 0.40% by mass of ytterbium oxide UU—HP (manufactured by Shin-Etsu Chemical Co. Ltd.) were added. Each of the resulting mixtures was melted and kneaded, and was further ground and classified in order to obtain each toner base with a volume average particle diameter (D₅₀) of 9 μm.

As an additive, hydrophobic silica (H-2000, manufactured by Clariant K.K.) was added in the amount of 0.35 parts by mass to every 100 parts by mass of each toner base, resulting in obtaining each toner for electrophotography of Examples 1 to 10 and Comparative Examples 1 to 9.

Each of the resulting toner for electrophotography was charged in a modified machine of a printer (product number; PS2160, manufactured by Fujitsu Limited). Thus, the toner was irradiated with a xenon flashlight having a high light emission intensity in the wavelength range of 700 to 1000 nm, and fixed on plain paper (NIP-1500LT, manufactured by Kobayashi Tenshazai Co., Ltd.), which resulted in a printed image including a filled-in part of 1 inch×1 inch. The resulting filled-in image and the background (non-printed) portion in the near-field of the image were determined for the color tone (color produceability) and concentration of blurring and fogging (sublimation-resistance) by means of a chromosome (X-Rite 938), and evaluated according to the following criteria. The results of evaluations are shown Tables 1 and 2.

—Evaluation of Concentration of Blurring and Fogging (Sublimation Resistance)—

The concentration of blurring and fogging in the near-field of a printed portion was evaluated based on the color difference (ΔE) when standard paper (L*=89.20, a*=−0.28, b*=0.73) was used. The results were evaluated according to the following criteria.

When the color difference (ΔE) is 5 or more . . . ⊚

When the color difference (ΔE) is more than 5 and less than 20 . . . ◯

When the color difference (ΔE) is 20 or more . . . ×

—Evaluation of Color Tone (Color Produceability)—

The chroma C=((a*)²+(b*)²)^{1/2} of each printing sample was determined, and evaluated according to the following criteria:

When the chroma C is 70 or more . . . ⊚

When the chroma C is more than 60 and less than 70 . . . ◯

When the chroma C is 60 or less . . . ×

TABLE 1

| | | Ex. | Ex. | Ex. | Ex. | Ex. | Ex. | Ex. | Ex. | Ex. | Ex. |
|---|---|---|---|---|---|---|---|---|---|---|---|
| | | 1 | 2 | 3 | 4 | 5 | 6 | 7 | 8 | 9 | 10 |
| C.I. pigment Yellow 74 | | 1 | 1 | 0.5 | 0.5 | 1 | 2 | 3 | 4 | 4.5 | 6 |
| (content (% by mass)) | | | | | | | | | | | |
| C.I. pigment Yellow 180 | | 8 | 7 | 5 | 4.5 | 4 | 3 | 2 | 1 | 0.5 | 1 |
| (content (% by mass)) | | | | | | | | | | | |
| Fixing | Concentra- | ⊚ | ⊚ | ⊚ | ⊚ | ⊚ | ⊚ | ⊚ | ⊚ | ⊚ | ◯ |
| energy = | tion of | | | | | | | | | | |
| 3 (J/cm²) | blurring | | | | | | | | | | |
| | and fogging | | | | | | | | | | |
| | (sublimation | | | | | | | | | | |
| | resistance) | | | | | | | | | | |
| | Color tone | ◯ | ◯ | ⊚ | ⊚ | ⊚ | ⊚ | ⊚ | ⊚ | ⊚ | ⊚ |
| | (color pro- | | | | | | | | | | |
| | duceability) | | | | | | | | | | |

TABLE 2

| | | Comp. | Comp. | Comp. | Comp. | Comp. | Comp. | Comp. | Comp. | Comp. |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 |
| C.I. pigment Yellow 74 | | 0 | 0 | 0 | 0 | 7 | 8 | 9 | 10 | 11 |
| (content (% by mass)) | | | | | | | | | | |
| C.I. pigment Yellow 180 | | 11 | 10 | 9 | 8 | 0 | 0 | 0 | 0 | 0 |
| (content (% by mass)) | | | | | | | | | | |
| Fixing | Concentration of | ⊚ | ⊚ | ⊚ | ⊚ | X | X | X | X | X |
| energy = | blurring and fogging | | | | | | | | | |
| 3 (J/cm²) | (sublimation resistance) | | | | | | | | | |
| | Color tone (color | X | X | X | X | ⊚ | ◯ | ◯ | X | X |
| | produceability) | | | | | | | | | |

The results of Tables 1 and 2 indicate as follows. Namely, the sublimation-resistance depends on the content of C.I. pigment Yellow 74. If the content exceeded 5% by mass (Example 10), the sublimation-resistance tended to worsen. If the content was 8% by mass (Comparative Example 6), the fogging due to a pigment was observed on plain paper. On the other hand, for C.I. pigment Yellow 180, even if the content was 11% by mass (Comparative Example 1), no fogging, or the like were observed. However, regarding C.I. pigment Yellow 180, if the content exceeded 5% by mass (Example 3), the chroma greatly varied, and it hence decreased. If the content was 8% by mass (Comparative Example 4), the chroma decreased to 60 or less, and there observed poor printing because of the insufficient color produceability.

With the toner for electrophotography obtained in Example 5 and the toner for electrophotography obtained in Example 9, the relationships of the concentration of blurring and fogging (sublimation-resistance) and the color tone (color produceability) with the fixing energy (J/cm²) were determined and evaluated by means of a chromoscope (X-Rite 938). The evaluation results are shown in Table 3.

TABLE 3

| Toner for electrophotography | Fixing energy (J/cm²) | | | | | |
|---|---|---|---|---|---|---|
| obtained in Example 9 | 1 | 2 | 3 | 4 | 5 | 6 |
| Concentration of blurring and | ⊚ | ⊚ | ⊚ | ◯ | ◯ | X |
| fogging (sublimation resistance) | | | | | | |
| evaluation | | | | | | |
| Color tone (color produceability) | X | ⊚ | ⊚ | ⊚ | ⊚ | ◯ |
| evaluation | | | | | | |
| Toner for electrophotography | Fixing energy (J/cm²) | | | | | |
| obtained in Example 5 | 1 | 2 | 3 | 4 | 5 | 6 |
| Concentration of blurring and | ⊚ | ⊚ | ⊚ | ⊚ | ⊚ | X |
| fogging (sublimation resistance) | | | | | | |
| evaluation | | | | | | |
| Color tone (color produceability) | X | ⊚ | ⊚ | ⊚ | ⊚ | ◯ |
| evaluation | | | | | | |

The results shown in Table 3 reveals the following points. Namely, if the fixing energy is less than 2 J/cm², the fixability of the toner deteriorates, hence chrom also worsens because sufficient surface smoothness is unable to be obtained. Therefore, the color tone tended to decrease. Whereas, if the fixing energy exceeds 5 J/cm², it was observed that fogging is likely to occur on plain paper due to the pigment.

As mentioned above, the color produceability and the sublimation-resistance are particularly excellent in the sate that the fixing energy for flash fixing is 2 to 5 J/cm², and the content of C.I. pigment Yellow 74 is 5% by mass or less. Further, the content of C.I. pigment Yellow 180 does not affect the sublimation-resistance. However, in order to obtain good color tone or chroma, the content is preferably 7% by mass or less, and particularly, at a fixing energy of 3 J/cm², the total content of C.I. pigment Yellow 74 and C.I. pigment Yellow 180 is preferably 5% by mass or less.

According to the present invention, the various problems in the related art can be solved. It is possible to provide a toner for electrophotography, a developer for electrophotography, an apparatus for forming an image, and a method for forming an image, all of which are excellent in color produceability and reproducibility as well as sublimation-resistance, and will not cause fogging of an image or a printing defect.

What is claimed is:

1. A toner for electrophotography comprising:
C.I. pigment Yellow 74; and
C.I. pigment Yellow 180.

2. A toner for electrophotography according to claim 1, wherein the total content of the C.I. pigment Yellow 74 and the C.I. pigment Yellow 180 is 7% by mass or less.

3. A toner for electrophotography according to claim 1, wherein the content of the C.I. pigment Yellow 74 is 5% by mass or less.

4. A toner for electrophotography according to claim 1, wherein the content of the C.I. pigment Yellow 180 is 5% by mass or less.

5. A toner for electrophotography according to claim 1, further comprising an infrared absorbent.

6. A toner for electrophotography according to claim 5, wherein the content of the infrared absorbent is 0.1 to 20% by mass or less.

7. A toner for electrophotography according to claim 1, further comprising a charge control agent.

8. A toner for electrophotography according to claim 7, wherein the charge control agent is one of a colorless and a light colored.

9. A toner for electrophotography according to claim 1, further comprising wax having a softening point of 150° C. or less.

10. A developer for electrophotography comprising a toner for electrophotography,
wherein the toner for electrophotography comprises
C.I. pigment Yellow 74 and C.I. pigment Yellow 180.

11. An apparatus for forming an image, comprising:
an electrostatic latent image carrier;
means for forming an electrostatic latent image on the electrostatic latent image carrier;
means for developing the electrostatic latent image and forming a visible image with a toner for electrophotography; and
means for transferring a transfer image formed by the visible image, onto a transfer material,
wherein the toner for electrophotography comprises C.I. pigment Yellow 74 and C.I. pigment Yellow 180.

12. An apparatus for forming an image according to claim 11, further comprising means for flash fixing.

13. An apparatus for forming an image according to claim 12, wherein the means for flash fixing exhibits a high light emission intensity in the wavelength range of 700 to 1000 nm.

14. An apparatus for forming an image according to claim 12, wherein the means for flash fixing is a xenon flash lamp.

15. A method for forming an image, comprising: A
a step for forming an electrostatic latent image on an electrostatic latent image carrier;
a step for developing the electrostatic latent image using a toner for electrophotography and forming a visible image; and
a step for transferring a transfer image formed by the visible image, onto a transfer material,
wherein the toner for electrophotography comprises C.I. pigment Yellow 74 and C.I. pigment Yellow 180.

16. A method for forming an image according to claim 15, further comprising a step for flash fixing the visible image transferred onto the transfer material.

17. A method for forming an image according to claim 16, wherein a fixing energy for flash fixing is 2 to 5 J/cm².
